(19) United States
(12) Patent Application Publication
(10) Pub. No.: US 2021/0059245 A1
(43) Pub. Date: Mar. 4, 2021

(54) CHEMICAL DISPENSER

(71) Applicant: Trécé, Inc.,, Adair, OK (US)

(72) Inventor: Vincent James Chebny, Tulsa, OK (US)

(21) Appl. No.: 17/091,643

(22) Filed: Nov. 6, 2020

Related U.S. Application Data
(63) Continuation-in-part of application No. PCT/US2019/031386, filed on May 8, 2019.
(60) Provisional application No. 62/839,141, filed on Apr. 26, 2019.
(60) Provisional application No. 62/668,749, filed on May 8, 2018.

(51) Int. Cl. A01N 25/10; A01N 31/02; A01N 37/02; A01M 1/10; A01M 1/02

(52) U.S. Cl. CPC A01N 25/10; A01N 31/02; A01M 1/02; A01M 1/106; A01N 37/02

(57) ABSTRACT

An insect trap includes a lure having one or more attractant compounds. The attractant compounds optionally including compounds of different volatility. The lure including a membrane configured to control release rates of the attractant compounds such that a release rate of a compound having greater volatility has its release rate lowered by a greater percentage or amount than a release rate of a compound having lower volatility. Inclusion of the membrane allows for adjustment of the relative release rates such that both compounds are released together over a longer time than would occur without the membrane. The lure is optionally disposed in a trap.

### CROSS-REFERENCE TO RELATED APPLICATIONS

This application is a Continuation-in-part of PCT application Ser. No. PCT/US19/31386 filed May 8, 2019; which in turn claims priority and benefit of U.S. provisional patent application Ser. Nos. 62/668,749 filed May 8, 2018 and 62,839,141 filed Apr. 26, 2019. The disclosures of these applications are hereby incorporated herein by reference.

### BACKGROUND

### Field of the Invention

The invention is in the field of insect control and more specifically in the field of chemical dispenser systems for insect control.

### Related Art

Multi-component dispensers for pest control compounds are known. See, for example, U.S. non-provisional patent application Ser. No. 15/547,785 filed Jul. 31, 2017. In a typical use, active compounds are disposed in a support matrix and their release into the environment is limited by a diffusion membrane. Compounds must diffuse through the diffusion membrane in order to be released. Their release rate is, therefore, often limited by the rate of diffusion through the diffusion membrane. As a result, larger molecules may be released at substantially lower rates then smaller molecules.

### SUMMARY

A multi-layer dispenser system includes a perforated membrane configured to control release of one or more compounds from a dispenser. The membrane is optionally configured to modify the relative release rates of low and high volatility compounds so as to achieve a desirable ratio of release rates between these compounds. Use of the perforated membrane results in release rates that are more dependent on 1) relative volatilities of the compound and/or 2) diffusion rates through their support matrix, rather than their relative diffusion rates through a diffusion membrane. The desirable ratio optionally results in a greater time period of simultaneous effective release of the compounds as compared to undesirable ratios of release rates.

The multiple compounds are optionally selected to attract and/or disrupt the mating of spotted wing drosophila, i.e., Drosophila suzukii and the dispenser may be disposed in a trap configured to capture this insect.

In various embodiments the dispenser includes a chemical dispenser comprising: an active layer configured to release at least a first compound and a second compound, the first compound being more volatile than the second compound; a backing layer configured to support the active layer; and a perforated membrane configured to control release rates of the first and second compounds such that the release rate of the first compound is reduced by a greater percentage and/or absolute amount than the release rate of the second compound.

Various embodiments include a method of attracting insects of the genus Drosophila, the method comprising: depositing a plurality of compounds in a diffusion material, the plurality of compounds including at least a first compound and a second compound, the first compound having a greater volatility than the second compound; attaching a backing layer to the diffusion material; and attaching a membrane to the diffusion material, the membrane including perforations configured to control release rates of the first and second compounds such that the release rate of the first compound is reduced by the membrane by a greater amount than the release rate of the second compound, the diffusion material being disposed between the backing layer and the membrane. Optionally, the release rates of the first and second compounds are primarily dependent on their desorption rates from the diffusion material to the atmosphere.

### BRIEF DESCRIPTION OF THE DRAWINGS

FIG. 1 illustrates an exploded view of a dispenser system, according to various embodiments of the invention.

FIG. 2 illustrates release of compounds from an active layer through a perforated membrane, according to various embodiments of the invention.

FIG. 3 illustrates a front view of a dispenser system, according to various embodiments of the invention.

FIG. 4 illustrates a dispenser system disposed within an insect trap, according to various embodiments of the invention.

FIG. 5 illustrates methods of constructing an insect trap, according to various embodiments of the invention.

FIGS. 6A-6C illustrate alternative dispenser systems, according to various embodiments of the invention.

### DETAILED DESCRIPTION

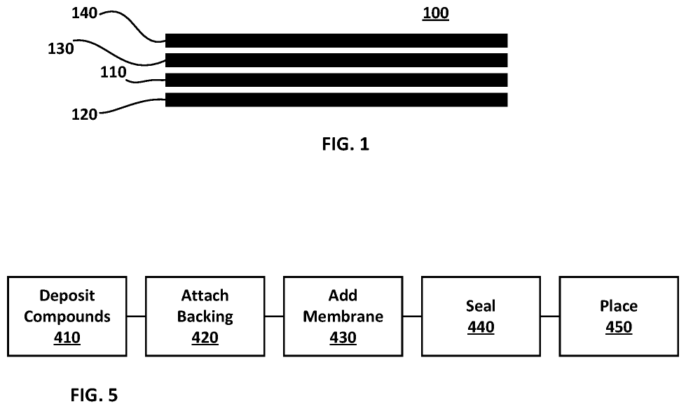

FIG. 1 illustrates an exploded view of a Dispenser System 100, according to various embodiments of the invention. Dispenser System 100 includes an Active Layer 110, an optional Backing Layer 120, a Perforated Membrane 130 and an optional Sealing Layer 140. Dispenser System 100 is optionally disposed within an insect trap. While FIG. 1 illustrates an exploded view, normally the various layers are in contact with each other, to form a single multi-layer device. For example, the various layers illustrated may be attached via an adhesive and/or intermediate layer.

Active layer 110 is configured to release at least a first compound and optionally a second compound or further compounds of different volatilities. For example, the first compound may be more volatile than the second compound. Active Layer 110 can include two or more active compounds including, for example, Acetoin, Methionol, Ethanol, Acetic Acid, any of the compounds disclosed in U.S. patent application Ser. Nos. 15/730,412, 15/547,785, 15/596,418, 62/570,809, 62/406,811, 62,839,141 and/or any other compounds known to kill insects, attract insects and/or disrupt insect mating. The compounds may be selected to control any of the insects discussed in the above patent applications. The above U.S. patent applications are hereby incorporated herein by reference. The compounds within Active Layer 110 are optionally configured to attract and/or disrupt the mating of spotted wing drosophila (Drosophila suzukii). Active Layer 110 optionally includes on or more of methanol, acetalaldehyde, ethyl acetate, alpha pinene and phenyl propionate.

In some embodiments, Active Layer 110 includes an extruded polymer, such as Polyvinyl Chloride (PVC). In these embodiments, active insect control agents are optionally co-extruded with the polymer.

In various embodiments, Active Layer 110 includes an active agent mixture of any combination of at least one, two, three or four of Acetoin, Methionol, Ethanol and Acetic Acid. Active Layer 110 also typically includes a thickening agent such as Klucel H IND hydroxypropylcellulose. Alternative thickening agents include: Methylcellulose, Hydroxylethylcellulose, Xanthan Gum, Locust bean gum, Geltain, Carbomer, Polyvinyl alcohol and/or Sodium alginate. These thickening agents may form a gel including the active agent mixture. In various embodiments Active Layer 110 includes cotton, cellulose, silica, diatomaceous earth, plastics, and/or the like. Active Layer 110 can include 1, 2, 3, 4 or more compounds selected for insect control. Active Layer 110 typically includes a diffusion material through which these compounds can diffuse, and from which they may desorb into the atmosphere.

Optionally, different components of the active mixture are disposed in different regions of Active Layer 110. For example, Acetic Acid may be disposed in a first area of Active Layer 110 while Acetoin and/or Methional are disposed in a second area of Active Layer 110.

Backing Layer 120 is configured to support Active Layer 110. In some embodiments Backing Layer 120 includes an Aluminum/poly chemical barrier plastic membrane. Alternatively, Backing Layer 120 can include any chemical barrier plastic. Depending on the material, Backing Layer 120 can have a thickness of less than 1 mil, between 1 mil and 25 mil, or greater than 25 mil.

Perforated Membrane 130 is configured to control release rates of the one, two or more compounds via perforations in Perforated Membrane 130. Using Perforated Membrane 130 release rates of compounds are dependent on desorption rates of the compounds from Active Layer 110 and/or diffusion rates of the compounds within Active Layer 110, rather than diffusion rates of the compounds through a solid portion of Perforated Membrane 130 or other rate limiting membrane. Thus, Perforated Membrane 130 allows for control of release rates while allowing relative release rates to be dependent on desorption rates from Active Layer 110 rather than on diffusion rates through a diffusion membrane separate from Active Layer 110. For example, in some embodiments, Perforated Membrane 130 is configured (via material, thickness, perforation density and perforation size) such that the release rate of a first compound is changed by a greater percentage and/or absolute amount than the release rate of a second compound, relative to their release rates through a diffusion membrane or their release rates without a rate limiting membrane. By changing the release rate of the more volatile compound(s) by a different factor and/or amount than the release rate of the less volatile compound(s), it is possible to arrange for release of all the compounds over an extended period of time, e.g., at least ½, 1, 2, 3, 4 or 5 weeks, or at least 1, 2, 3 or 4 months.

The perforations of Perforated Membrane 130 are optionally different in size and/or density at different locations within Perforated Membrane 130. For example, in some embodiments, perforations are smaller and/or less dense in regions of Perforated Membrane 130 overlaying a region of Active Layer 110 including a greater concentration of volatile members of the active mixture, relative to a region of Active Layer 110 including a greater concentration of less volatile members of the active mixture. The release time of compounds can, thus, be selected by varying the perforation size, location and/or density. Configurations of the perforations that most reduce release rate are optionally disposed in areas of Perforated Membrane 130 adjacent to regions of Active Layer 110 that include a greater concentration of volatile active compounds.

In some embodiments, Perforated Membrane 130 includes a 3 mil Polyethylene sheet including 150 micrometer diameter perforations. In various embodiments, the perforations are less than 50, between 50 and 100, between 100 and 200, between 200 and 300, or more than 300 micrometers in diameter. The openings of perforations can cover less than 0.1%, 0.5%, 1%, between 1%-3%, between 3%-5%, between 5%-10%, between 10%-25%, between 25%-35% or more than 35% of the surface of the membrane. In various embodiments, Perforated Membrane is less than 1 mil, between 1 and 10 mil, between 10 and 25 mil, or greater than 25 mil in thickness. In various embodiments, Perforated Membrane 130 can include other plastics such as: Polyamides (PA), Polycarbonate (PC), Polyester (PES), Polyethylene (PE), High-density polyethylene (HDPE), Low-density polyethylene (LDPE), Polyethylene terephthalate (PET), Polypropylene (PP), Polystyrene (PS), High impact polystyrene (HIPS), Polyurethanes (PU), Polyvinyl chloride (PVC), Polyvinylidene chloride (PVDC), Acrylonitrile butadiene styrene (ABS), Polycarbonate/Acrylonitrile Butadiene Styrene (PC/ABS), Polyethylene/Acrylonitrile Butadiene Styrene (PE/ABS), Polyepoxide (epoxy) Polymethyl methacrylate (PMMA), Polytetrafluoroethylene (PTFE), Phenolics or phenol formaldehyde (PF), Melamine formaldehyde (MF) Urea-formaldehyde (UF), Polyetheretherketone (PEEK), Polyetherimide (PEI), Polyimide Plastarch material Polylactic acid (PLA), Furan Silicone Polysulfone, and/or the like. A spacing layer is optionally disposed between Active Layer 110 and Perforated Membrane 130.

Some embodiments include more than one Active Layer 110. For example, Dispenser System 100 may include a first Active Layer 110 including a first compound (active insect control agent) and a second Active Layer 110 including a second compound (active insect control agent). The first and second Active Layers 110 are optionally in contact with different Perforated Membranes 130. These different Perforated Membranes 130 may have different perforation characteristics, e.g., different hole sizes and/or number of holes per unit area.

Backing Layer 120 is optional in embodiments where Perforated Membrane 130 covers all or most sides of Active Layer 110. For example, in various embodiments, Active Layer 110 is in the shape of a cylinder (e.g., an extruded cylinder) and Perforated Membrane 130 may be wrapped around the circumference of the cylinder. Backing Layer 120 and/or Perforated Membrane 130 may or may not be disposed at the ends of the cylinder. Active Layer 110 may take a wide variety of shapes having, for example, cross sections that are square, oval, round, rectangular, triangular, diamond, star shaped, and/or the like.

Sealing Layer 140 is configured to prevent release of the first and second compounds (or other compounds within Active Layer 110) until Sealing Layer 140 is removed. Typically, Sealing Layer 140 is removed when Dispensing Device 100 is place in use, e.g., in a field or orchard. In some embodiments, Sealing Layer 140 includes a peelable aluminum/poly layer around 6 mil thick. Alternatively, Sealing Layer 140 can include any plastic chemical barrier, nylon, PVC, and/or the like.

In various embodiments, Perforated Membrane 130, Backing Layer 120, and/or Sealing Layer 140 include material configured to block light, e.g., UV light. Such materials may be selected to prevent photodegradation of insect management compounds within Active Layer 110.

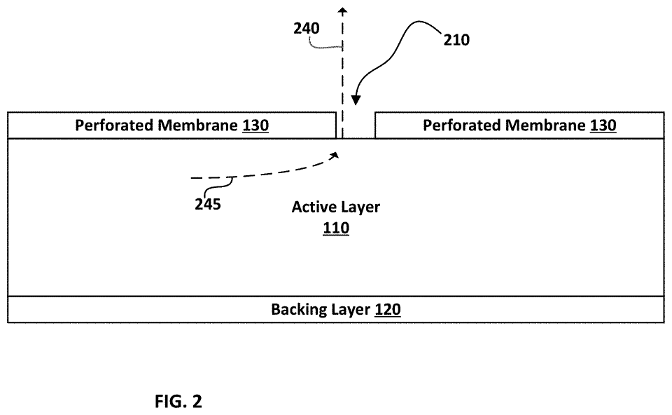

FIG. 2 illustrates release of compounds from an active layer through a perforated membrane, according to various embodiments of the invention. Active compounds can Desorb 240 from Active Layer 110 via Pore 210 and be released into the atmosphere. They can also Diffuse 245 through Active Layer 110 to reach Pore 210. In various embodiments, the release rate of active compounds from Active Layer 110 to the atmosphere via Pore 210 is at least 100, 1000 or 10,000 times greater than release via diffusion through solid parts of Perforated Membrane 130. The release rates of active compounds are thus primarily dependent on rates of Desorption 240 and/or Diffusion 245. At the same time, the presence of Perforated Membrane 130 reduces overall release rates (relative to having no release limiting membrane) such that release periods are extended to commercially viable times.

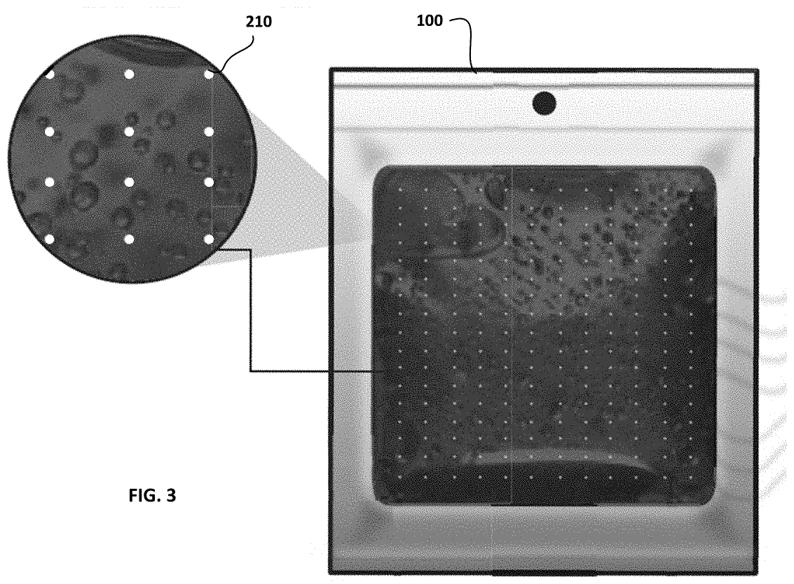

FIG. 3 illustrates a front view of Dispenser System 100 (without Sealing Layer 140), according to various embodiments of the invention. Included in FIG. 3 is a magnified view of a regions in which Pores 210 can be seen. In alternative embodiments, Dispenser System 100 can take a wide variety of shapes and sizes.

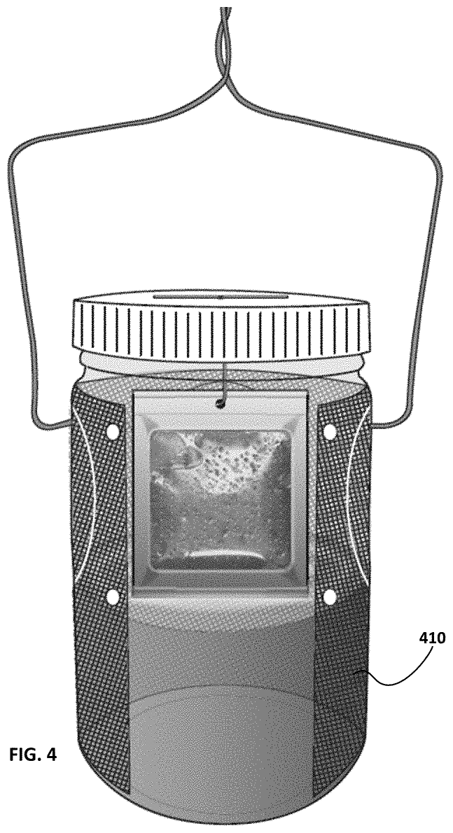

FIG. 4 illustrates a dispenser system disposed within an insect Trap 410, according to various embodiments of the invention. Trap 410 may be hung from a tree or placed on a surface. Trap 410 is optionally configured to trap Drosophila suzukii.

FIG. 5 illustrates methods of constructing an insect lure and trap, according to various embodiments of the invention. In a Deposit Compounds Step 410, one or more compounds are deposited or mixed in a diffusion material, such as Active Layer 110. The one or more compounds optionally including at least a first compound and a second compound, the first compound having a greater volatility than the second compound. The one or more compounds can include, for example 1, 2, 3, 4 or more compounds configured to attract and/or disrupt mating of insects of the genus Drosophila. In one example the compounds includes Acetoin, Methionol, Ethanol and Acetic Acid. The compounds deposited in Deposit Compounds Step 410 can include any of the compounds disclosed in U.S. patent application Ser. Nos. 15/730,412, 15/547,785, 15/596,418, 62/570,809, 62/406,811, 62,839,141 and/or any other compounds known to attract insects and/or disrupt insect mating.

In an optional Attach Backing Step 420, a backing is attached to the diffusion material. This backing is configured to support the diffusion material. Attach Backing Step 420 is optional in embodiments wherein the diffusion material is self supporting. In these embodiments, Backing Layer 120 is optional and Perforated Membrane 130 may be placed on two sides of Active Layer 110. Backing Layer 120 may also be optional if diffusion material is of a shape, e.g., cylindrical that can be completely covered by membrane such as a single Perforated Membrane 130.

In an Add Membrane Step 430, a perforated membrane, e.g., Perforated Membrane 130, is attached to the Active Layer 110. As discussed elsewhere herein, the perforated membrane includes perforations configured to control release rates of 1, 2, 3, 4 or more compounds. In some embodiments, the perforations of the perforated membrane are configured such that the release rate of a first compound is reduced by the membrane by a greater amount and/or percentage than the release rate of a second compound. The perforated membrane is optionally added such that the diffusion material is between the backing layer and the perforated membrane, or such that the diffusion material is covered by the perforated membrane. Release rates of the compounds from the diffusion material are primarily dependent on desorption rates of the compounds from the diffusion material to the atmosphere, and/or primarily dependent on diffusion rates of the compounds within the diffusion material.

In an optional Seal Step 440, a removable seal, e.g. Seal Layer 140 is placed over the perforated membrane. The sealing layer is configured to prevent the active compounds with the Active Layer 110 from releasing to the atmosphere before the seal is removed.

In an optional Place Step 450, the seal is removed and the active material and perforated membrane are placed in an insect trap. The insect trap is optionally configured to trap insects of the genus Drosophila, e.g., Drosophila suzukii.

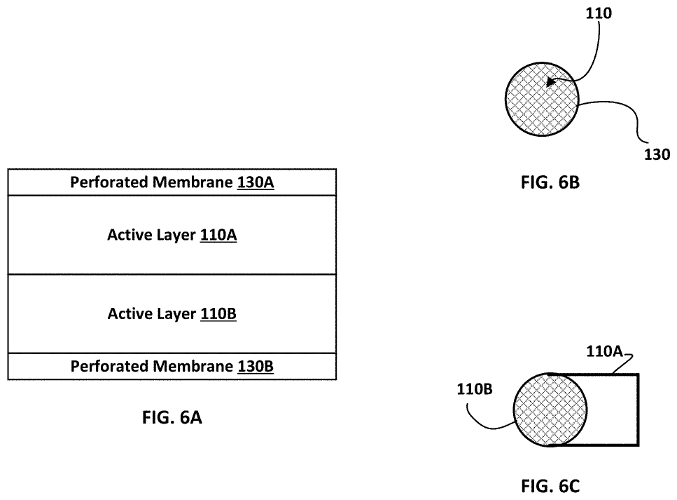

FIGS. 6A-6C illustrate alternative dispenser systems, according to various embodiments of the invention. FIG. 6A illustrates an embodiment of Dispenser System 100 including two Active Layer 110A and 110B. As noted elsewhere herein, these two Active Layers 110 may include different insect control compounds and may be covered by different Perforated Membranes 130A and 130B having different perforation characteristics. For example, Active Layer 110A may include a relatively volatile insect control compound while Active Layer 110B includes a less volatile insect control compound. In this case, Perforated Membrane 130A may have smaller and/or fewer perforations; so as to reduce the release rate of the more volatile insect control compound relative to the less volatile insect control compound. The two Active Layers 110 may be attached to each other, making Backing Layer 120 optional. This attachment may be accomplished using an adhesive, connectors, co-extrusion, and/or the like.

FIG. 6B illustrates a cross section of a cylinder embodiment of Dispenser System 100. In such an embodiment, Perforated Membrane 130 is optionally wrapped around the circumference of the cylinder. FIG. 6C illustrates an embodiment in which two Active Layers 110 have different shapes. In such embodiments, the shape (and resulting surface to volume ratio) may be used to control relative release rates of insect control compounds in each of the Active Layers 110. A cylindrical shape is an example of a low surface to volume ratio while a star shape in an example of a relatively greater surface to volume ratio. A wide variety of shapes may be produced by molding or extrusion, etc.

Several embodiments are specifically illustrated and/or described herein. However, it will be appreciated that modifications and variations are covered by the above teachings and within the scope of the appended claims without departing from the spirit and intended scope thereof. For example, the systems and methods disclosed herein can be used in conjunction with a wide range of compounds configured to control one or more of a wide range of insects.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A chemical dispenser comprising:
an active layer configured to release at least a first compound and a second compound, the first compound being more volatile than the second compound; and
a perforated membrane configured to control release rates of the first and second compounds such that the release rate of the first compound is reduced by the membrane by a greater percentage than the release rate of the second compound is reduced by the membrane.

2. A chemical dispenser comprising:
an active layer configured to release at least a first compound and a second compound, the first compound being more volatile than the second compound; and
a perforated membrane configured to control release rates of the first and second compounds such that the release rates of the first and second compounds are primarily dependent on their desorption rates from the active layer to atmosphere, the desorption occurring through the perforated membrane.

3. The dispenser of claim 2, wherein release of the first compound is reduced by the membrane by a greater amount than the release rate of the second compound is reduced by the membrane.

4. The dispenser of claim 2, wherein the release rate of the first compound is independent of a diffusion rate of the first compound through a solid portion of the perforated membrane.

5. The dispenser of claim 1, wherein the second compound includes acetoin and/or Methionol.

6. The dispenser of claim 1, wherein the active layer includes a thickening agent.

7. The dispenser of claim 1, wherein the perforated membrane includes perforations between 50 and 250 micrometers in diameter.

8. The dispenser of claim 1, wherein perforations of the perforated membrane occupy between 1 and 10% of a surface of the perforated membrane.

9. The dispenser of claim 1, wherein the perforated membrane includes polyethylene.

10. The dispenser of claim 1, wherein the first or second compound is configured to attract spotted wing drosophila (Drosophila suzukii).

11. The dispenser of claim 1, wherein the first or second compound is configured to disrupt spotted wing drosophila (Drosophila suzukii) mating.

12. The dispenser of claim 1, further comprising a sealing layer configured to prevent release of the first and second compounds from the dispenser, the perforated membrane being disposed between the sealing layer and the active layer.

13. The dispenser of claim 1, further comprising an insect trap,
the chemical dispenser being disposed within the insect trap.

14. The dispenser of claim 1, wherein the first compound includes acetic acid and/or ethanol.

15. A method of attracting insects of the genus Drosophila, the method comprising:
depositing a plurality of compounds in a diffusion material, the plurality of compounds including at least a first compound and a second compound, the first compound having a greater volatility than the second compound;
attaching a backing layer to the diffusion material; and
attaching a membrane to the diffusion material, the membrane including perforations configured to control release rates of the first and second compounds such that the release rate of the first compound is reduced by the membrane by a greater amount than the release rate of the second compound, the diffusion material being disposed between the backing layer and the membrane.

16. The method of claim 15, further comprising attaching a sealing layer to the membrane, the sealing layer being configured for preventing release of the first and second compound.

17. The method of claim 15, further comprising placing the diffusion material in a trap configured to trap insects of the species Drosophila suzukii.

18. The method of claim 15, wherein the release rates of the first and second compounds are primarily dependent on their desorption rates from the diffusion material to atmosphere, the release occurring through the membrane.

19. The dispenser of claim 1, further comprising a backing layer configured to support the active layer, wherein the active layer is disposed between the backing layer and the perforated membrane.

20. The dispenser of claim 2, further comprising an optional backing layer configured to support the active layer wherein the active layer is disposed between the backing layer and the perforated membrane.
